(19) United States
(12) Patent Application Publication
(10) Pub. No.: US 2016/0339582 A1
(43) Pub. Date: Nov. 24, 2016

(54) SPARE TIRE MOUNTED LOCKABLE TOOL SAFE

(71) Applicant: Matthew Little, Colleyville, TX (US)

(72) Inventor: Matthew Little, Colleyville, TX (US)

(21) Appl. No.: 14/179,918

(22) Filed: Feb. 13, 2014

(51) Int. Cl. B25H 5/00; B60R 9/06

(52) U.S. Cl. CPC B25H 5/00; B60R 9/06

(57) ABSTRACT

A spare tire mounted lockable tool safe includes a cylindrical body, adapted to fit within a wheel fixed to the spare tire for a vehicle; a back plate of the body; a wheel attachment mechanism on the back plate, adapted to releasably retain the wheel; a front plate having a lower section and an upper section; a vehicle attachment mechanism on the lower section of the front plate, adapted to attach to the vehicle; an access panel on the upper section of the front plate, hingeably attached to the lower section of the front plate; a metal lip on a rim of the upper section; and a lock on the access panel, adapted to engage with the metal lug so as to to lock the access panel closed against the body.

### RELATED APPLICATIONS

This application claims the benefit of the filing date of U.S. Patent Application No. 61/353,434, filed Jun. 10, 2010, which is incorporated herein by reference in its entirety.

### BACKGROUND OF THE INVENTION

The present invention generally relates to equipment for vehicles and more specifically to a spare tire mounted lockable tool safe.

Existing spare tire carriers for a vehicle, such as an SUV, trailer, a recreational vehicle or a semi-truck, only provide support to store the spare tire itself. These spare tire carriers are often attached to a mounting plate or bracket, which is vertically-mounted at the back or sides of the vehicle. These carriers to not exploit the volume of space taken up by the carrier itself for any other useful purpose.

It would be desirable to have a spare tire mount that is also a lockable tool safe.

### SUMMARY OF THE INVENTION

In one aspect of the present invention, a device for a wheel of a vehicle includes a cylindrical body, adapted to fit within the wheel; a back plate of the body; a wheel attachment mechanism on the back plate, adapted to releasably retain the wheel; a front plate having a lower section and an upper section; a vehicle attachment mechanism on the lower section of the front plate, adapted to attach to the vehicle; an access panel on the upper section of the front plate; and a locking mechanism on the access panel to lock the access panel closed against the body.

In another aspect of the present invention, a spare tire mounted lockable tool safe includes a cylindrical body, adapted to fit within a wheel fixed to the spare tire for a vehicle; a back plate of the body; a wheel attachment mechanism on the back plate, adapted to releasably retain the wheel; a front plate having a lower section and an upper section; a vehicle attachment mechanism on the lower section of the front plate, adapted to attach to the vehicle; an access panel on the upper section of the front plate, hingeably attached to the lower section of the front plate; a metal lip on a rim of the upper section; and a lock on the access panel, adapted to engage with the metal lug so as to to lock the access panel closed against the body.

In yet another aspect of the present invention, a vehicle wheel mounted tool safe includes a cylindrical body having two ends; a back plate attached to one end of the cylindrical body, the back plate adapted to be attached to a tire wheel; a front plate comprising a bottom section attached to the other end of the cylindrical body, the front plate adapted to be attached to a mounting bracket on a vehicle, the front plate having a top section hingeably attached to the bottom section; and a locking mechanism in the top section of the front plate, wherein when the back plate is attached to the wheel of a spare tire and the bottom section of the front plate is attached to the mounting bracket, the cylindrical body, together with the back plate and front plates, provide a vehicle storage safe that is accessed through the top section of the front plate and secured by the locking mechanism in the top section.

### BRIEF DESCRIPTION OF THE DRAWINGS

FIG. 1 shows a conventional original equipment configuration of a motor vehicle having a spare tire vertically mounted on a mounting plate at the rear of the vehicle;

FIG. 2 is a section view of an exemplary embodiment of a tool safe mounted in a spare tire wheel, according to the present invention;

FIG. 3 is a front view of the embodiment of a tool safe depicted FIG. 2; and

FIG. 4 is a rear view of the embodiment of a tool safe depicted FIG. 2.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

Broadly, an embodiment of the present invention generally provides a toolbox or safe that can fit inside the wheel of a spare tire and serves the purpose of holding the spare tire to the vehicle.

Embodiments of a spare tire may be attached to the exterior of the rear end or side of a vehicle. The vehicle may be an SUV, trailer, a recreational vehicle or a semi-truck. Embodiments may provide a virtual automotive backpack or spare tire carrier that is also a steel, lockable tool box, inconspicuously hidden behind the spare tire. Users may use embodiments to keep emergency tools at the ready or lock up your valuables when the user leaves the vehicle. Embodiments may provide storage for gloves, jumper cables, tow straps, plug kit, tire gauge, multi tools, flashlight, first aid kits, or other items to be stored.

Embodiments of a tool safe may replace the exterior vertically mounted spare tire carrier of original equipment. Embodiments may be mounted to the vehicle using a specially manufactured backing plate, which may be first fitted to the vehicle, and then to the tool safe using approximately five mounting holes or apertures in the bottom section of the front panel. Alternatively, the tool safe may be welded or fastened in another manner to a steel after-market spare tire carrier.

In an exemplary embodiment, a tool safe may have specific measurements for a specific wheel, which would vary depending on wheel size. For example, an embodiment of a tool safe that measured substantially 14¾ inches in outer diameter and 8½ inches deep would fit into a 17 by 8½ inch aluminum wheel of an original equipment manufacturer (OEM) Jeep™ vehicle. Embodiments may, for example, fit and work with up to 20″ wheels with a depth of 8″ standard width, with optional depths of 10″ and 12″.

The body of an embodiment of a tool safe may be a cylinder having a diameter and circumference determined by the inside dimensions of the wheel into which the embodiment will be fitted. The dimensions may be determined by measuring the length of the innermost section of the inside of the wheel and extending to the mounting pad or axle hub mounting surface. For example, if the inside diameter of the wheel is 14¾ inches, that number is multiplied by 3.14 to a length of 46.32 inches of material which is then rolled into the cylinder which makes the body 18. The body may also be made from pipe having an acceptable diameter and thickness.

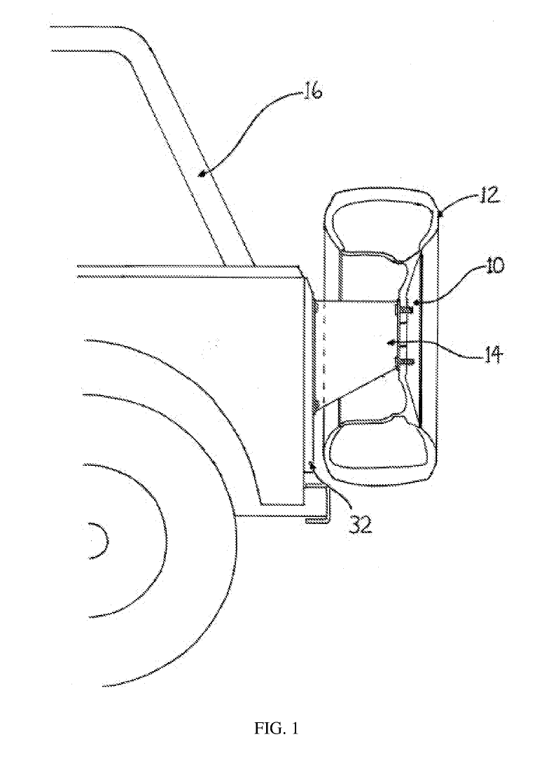

As depicted in FIG. 1, a spare wheel 10 and tire 12 for a vehicle 16 may include, as original equipment, an exterior spare tire carrier 14, which may be replaced by an embodiment of a tool safe. The tire carrier 14 may be vertically mounted on a mounting plate 32, and embodiments of the present invention may replace the tire carrier 14 to provide a lockable tool box. Embodiments may support other orientations and configurations, such as horizontally mounted underneath the vehicle 16, in a trunk of the vehicle 16, or mounted directly to the vehicle 16 itself.

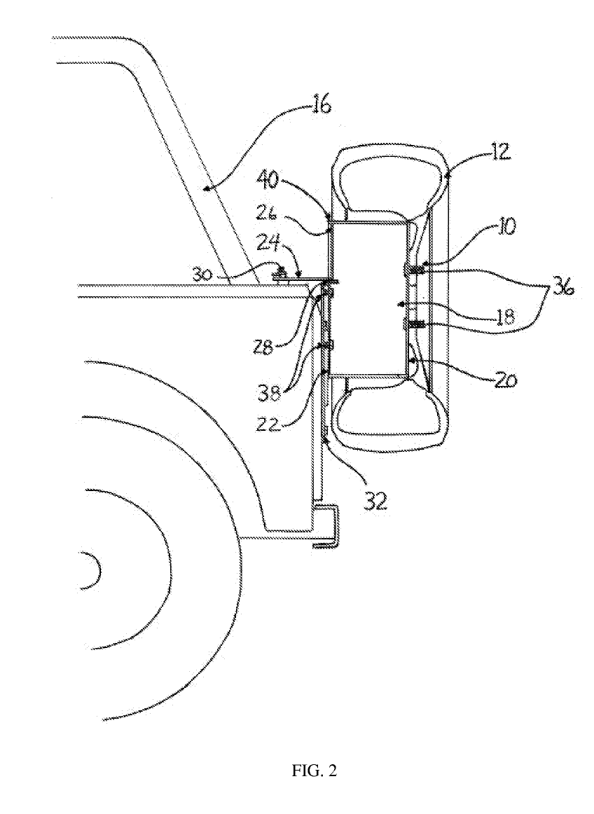

As depicted in FIG. 2, embodiments of a lockable tool safe 40 may include a cylindrical body 18, a back plate 20, and a front plate 22 with a lower section and an access panel 24 in an upper section. The access panel 24 may form the top front of the front plate 22, and may be joined to the bottom section of the front plate 22 by a hinge 28. The access panel 24 may also have a lock 30 to keep the access panel 24 locked shut against a metal lip 26 at the top of the body 18. The back plate 20 may have protruding wheel lug studs 36 to hold the spare wheel 10 and tire 12. In an embodiment, the bottom section of the front plate 22 may have holes and bolts 38 to use in attaching the tool safe 40 to a mounting plate 32 or other mounting bracket.

In an embodiment, the back plate 20 of a tool safe 40 may be substantially a solid circle having the same diameter as the inside of the body 18. The access panel 24 may enclose 50% or less of the front plate 22, and the bottom section of the front plate 22 may enclose 50% or more of the front plate 22 of the tool safe 40. Other embodiment may have a differently-sized access panel 24. Embodiments of a body 18 may be made of 1/16″ thick material depending on the material and the back plate 20 and upper and lower sections of the back plate 20 may be made of ⅛-inch thick material, depending on the material. One could use thicker or thinner material and/or steel/aluminum/hard formed plastic or other material of satisfactory strength. The body 18 may be enclosed by the back plate 20 and front plate 22, arranged so as to fit inside the edge of the cylindrical body 18 to be attached. Embodiments may include a wheel attachment mechanism with wheel lug studs to hold the back plate to the wheel, and a vehicle attachment mechanism with bolts to hold the front plate to the vehicle.

To make an embodiment, a back plate 20 of a tool safe 40 may be welded solidly around one end of the cylindrical body 18 to enclose the entire back side of the cylinder. The bottom section of the front plate 22 may be welded onto the other end of the body 18 of the tool safe 40. A hinge 28 may be welded between the bottom section of the front plate 22 and the top section access panel 24. Wheel lug studs 36 may be installed in the back plate 20 to hold the spare wheel 10 and tire 12. The stud heads may be located on the inside and then welded with their threaded ends protruding outside to mount and fasten the wheel 10 to the vehicle.

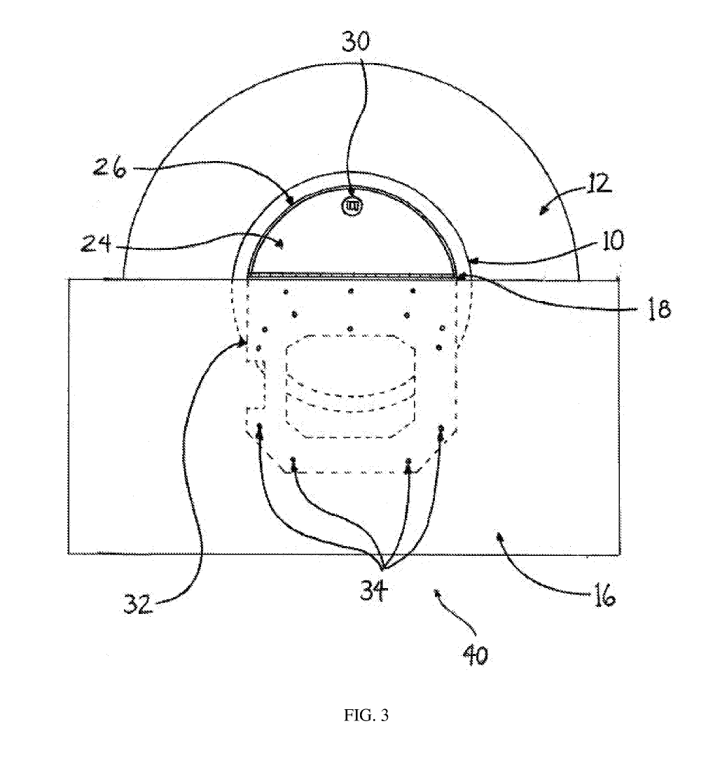

As depicted in FIG. 3, the bottom section of the front plate 22 may be attached to a mounting plate 32, which may have mounting bolts 34. The access panel 24 on the front plate 22 may have a hole drilled in the horizontal center about 1 inch from a top edge for the installation of a lock 30 which can be a thumbscrew or combination lock. A ½″ wide metal lip 26 may be welded inside the top section of the cylindrical body 18, encircling the inner top half or other portion of the cylinder where the access panel 24 closes, and may be placed ¼″ from the outer edge of the cylinder for the purpose of providing an access panel seat and a cam lock anchor for keeping the top section access panel 24 closed and locked.

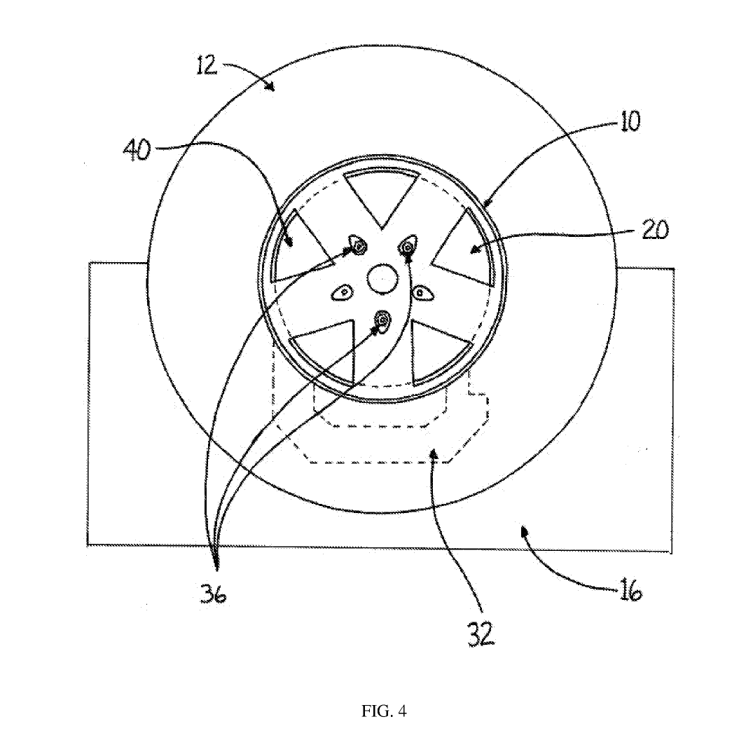

As depicted in FIG. 4, an embodiment of a back plate 20 may have a number of holes for bolts or protruding wheel lug studs 36, such as three studs positioned at a 2.5″ radius, 5″ diameter on center, with two grouped at the top or bottom and one centered on the opposite side of center. Wheel manufacturers may reference this as a “5 on 5” lug pattern, specifically meaning 5 lug holes on a centered 5 inch diameter pattern. However, for the purpose of holding a spare tire 12 and wheel 10, only three lug studs 36 may be appropriate.

When installed, the tool safe may provide not only a place to safely mount and store a spare wheel and tire, but also enclose secure storage space inside the spare tire wheel. It may have an opening on its front, the vehicle facing side, in which tools, gear or valuables may be stored and it can be locked securely.

An embodiment of a vehicle wheel mounted tool safe may comprise: a cylindrical body having two ends; a back plate attached to one end of the cylindrical body, the back plate adapted to be attached to a tire wheel; a front plate comprising a bottom section 5 attached to the other end of the cylindrical body, the front plate adapted to be attached to a mounting bracket on a vehicle, the front plate having a top section hingeably attached to the bottom section; and a locking mechanism in the top section of the front plate. When the back plate is attached to the wheel of a spare tire and the bottom section of the front plate is attached to the mounting bracket, the cylindrical body, together with the back plate and front plates, provide a vehicle storage safe that is accessed through the top section of the front plate and secured by the locking mechanism in the top section.

1. A device for a wheel of a vehicle, comprising:
a cylindrical body, adapted to fit within the wheel;
a back plate of the body;
a wheel attachment mechanism on the back plate, adapted to releasably retain the wheel;
a front plate having a lower section and an upper section;
a vehicle attachment mechanism on the lower section of the front plate, adapted to attach to the vehicle;
an access panel on the upper section of the front plate; and
a locking mechanism on the access panel to lock the access panel closed against the body;
wherein the vehicle attachment mechanism includes bolts to hold the front plate to the vehicle.

2. The device of claim 1, wherein the wheel is attached to a spare tire for the vehicle.

3. The device of claim 1, further comprising:
a metal lip on the inside of a rim of the upper section, adapted to engage with the locking mechanism.

4. The device of claim 3, wherein the locking mechanism is a thumbscrew that engages with the metal lip.

5. The device of claim 1, further comprising:
a hinge that rotatably joins the access panel with the lower section of the front plate, to be hingeably attached to the lower section.

6. The device of claim 1, wherein the wheel attachment mechanism includes wheel lug studs to hold the back plate to the wheel.

7. (canceled)

8. The device of claim 1, wherein the wheel attachment mechanism is adapted to fit a specific spare tire wheel for a specific vehicle, and the vehicle attachment mechanism is adapted to fit said specific vehicle.

9. The device of claim 1, wherein the wheel attachment mechanism is a first set of apertures, bolts, and nuts on a first side of the body, and the vehicle attachment mechanism is a second set of apertures, bolts, and nuts on a second side of the body.

10. The device of claim 1, further comprising:
a mounting plate having a first side adapted to attach to the vehicle attachment mechanism and a second side adapted to attach to the vehicle.

11. The device of claim 1, wherein the cylindrical body provides a vehicle storage safe that is accessed through the access panel and secured by the locking mechanism.

12. A spare tire mounted lockable tool safe, comprising:
a cylindrical body, adapted to fit within a wheel fixed to the spare tire for a vehicle;
a back plate of the body;
a wheel attachment mechanism on the back plate, adapted to releasably retain the wheel;
a front plate having a lower section and an upper section;
a vehicle attachment mechanism on the lower section of the front plate, adapted to attach to the vehicle;
an access panel on the upper section of the front plate, hingeably attached to the lower section of the front plate;
a metal lip on a rim of the upper section; and
a lock on the access panel, adapted to engage with the metal lug so as to to lock the access panel closed against the body;
wherein the wheel attachment mechanism includes a plurality of wheel lug studs to hold the back plate to the wheel, and the vehicle attachment mechanism includes a plurality of bolts to hold the front plate to the vehicle.

13. (canceled)

14. A vehicle wheel mounted tool safe, comprising:
a cylindrical body having two ends;
a back plate attached to one end of the cylindrical body, the back plate adapted to be attached to a tire wheel;
a front plate comprising a bottom section attached to the other end of the cylindrical body, the front plate adapted to be attached to a mounting bracket on a vehicle, the front plate having a top section hingeably attached to the bottom section; and
a locking mechanism in the top section of the front plate,
wherein when the back plate is attached to the wheel of a spare tire and the bottom section of the front plate is attached to the mounting bracket, the cylindrical body, together with the back plate and front plates, provide a vehicle storage safe that is accessed through the top section of the front plate and secured by the locking mechanism in the top section.
